(19) United States
(12) Patent Application Publication
(10) Pub. No.: US 2020/0341926 A1
(43) Pub. Date: Oct. 29, 2020

(54) ELECTRONIC APPARATUS INSTALLED WITH NON-VOLATILE MEMORY EXPRESS SOLID STATE DISK

(71) Applicants: Chang-Yu Tu, Taipei City (TW); Te-Ming Kung, Taipei City (TW); Wen-Shyan Lai, Taipei City (TW)

(72) Inventors: Chang-Yu Tu, Taipei City (TW); Te-Ming Kung, Taipei City (TW); Wen-Shyan Lai, Taipei City (TW)

(73) Assignee: COMPAL ELECTRONICS, INC., Taipei City (TW)

(21) Appl. No.: 16/593,972

(22) Filed: Oct. 4, 2019

(30) Foreign Application Priority Data
Apr. 29, 2019 (TW) 108114948

(51) Int. Cl. G06F 13/40; G06F 13/42; G06F 3/06

(52) U.S. Cl. CPC G06F 13/4022; G06F 13/4282; G06F 2213/0026; G06F 3/0613; G06F 3/0688

(57) ABSTRACT

An electronic apparatus installed with non-volatile memory express solid state disks (NVMe SSDs) is provided. The electronic apparatus includes a processor, a board management controller (BMC), a micro-controller, at least one first input and output (IO) expander, and a plurality of NVMe SSDs. The micro-controller is coupled to the processor and the BMC. The first IO expander is coupled between the micro-controller and the NVMe SSDs. The micro-controller reads a PRSNT # information and an IFDET # information of each of the NVMe SSDs through the first IO expander, and transmits the PRSNT # information and the IFDET # information of each of the NVMe SSDs to the processor and the BMC.

### CROSS-REFERENCE TO RELATED APPLICATION

This application claims the priority benefit of Taiwan application serial no. 108114948, filed on Apr. 29, 2019. The entirety of the above-mentioned patent application is hereby incorporated by reference herein and made a part of this specification.

### BACKGROUND

### Technical Field

The disclosure relates to an electronic apparatus, and more particularly to an electronic apparatus installed with non-volatile memory express solid state disks.

### Description of Related Art

With the advent of the non-volatile memory express solid state disk (NVMe SSD), the NVMe SSD is favored by the field of high-end storage applications for its advantages such as low delay, low power consumption, high read and write speed, etc. Also, servers and storage apparatuses installed with the NVMe SSDs are emerging in the market.

Referring to FIG. 1 hereinafter, FIG. 1 is a conventional electronic apparatus installed with NVMe SSDs. An electronic apparatus 100 includes a central processing unit (CPU) 110, a board management controller (BMC) 120, a complex programmable logic device (CPLD) 130, a micro-controller 140, an inter integrated circuit (I2C) switch 150, a light emitting diode module LEDM, and a plurality of NVMe SSDs 160_1 to 160_N, wherein the micro-controller 140 may be, for example, a micro-controller “PSOC1” available from Cypress Semiconductor Corporation.

The CPU 110 may be coupled to the NVMe SSDs 160_1 to 160_N through a peripheral component interconnect express (PCIe) bus PB to read an information of each of the NVMe SSDs 160_1 to 160_N. In addition, the CPU 110 may also be coupled to the CPLD 130 through a system management bus (SMBus) SB11, and the CPLD 130 is coupled to the NVMe SSDs 160_1 to 160_N. The CPU 110 may obtain a PRSNT # information and an IFDET # information of each of the NVMe SSDs 160_1 to 160_N through the SMBus SB11 and the CPLD 130. The CPU 110 may determine a hard disk type and a drive type of the NVMe SSD (for example, the NVMe SSD 160_1) according to the PRSNT # information and the IFDET # information of the NVMe SSD (for example, the NVMe SSD 160_1).

In addition, the CPU 110 is further coupled to the micro-controller 140 through the SMBus SB11, and the micro-controller 140 is coupled to the NVMe SSDs 160_1 to 160_N and the light emitting diode module LEDM, wherein the light emitting diode module LEDM has a plurality of light emitting diodes. The CPU 110 may transmit a status information of each of the NVMe SSDs 160_1 to 160_N to the micro-controller 140 through the SMBus SB11. The micro-controller 140 may generate a drive signal to drive the corresponding light emitting diode in the light emitting diode module LEDM according to the status information of each NVMe SSD (for example, the NVMe SSD 160_1), so that the user may determine the status of the NVMe SSD (for example, the NVMe SSD 160_1) by checking the light-on/light-off or color of the corresponding light emitting diode.

On the other hand, the BMC 120 is coupled to the micro-controller 140 and the I2C switch 150 through a SMBus SB12, wherein the I2C switch 150 is coupled to the NVMe SSDs 160_1 to 160_N through a SMBus SB13. Similarly, the BMC 120 may obtain the PRSNT # information and the IFDET # information of each of the NVMe SSDs 160_1 to 160_N through the SMBus SB12 and the micro-controller 140. Also, the BMC 120 may read a temperature value, a vital product data (VPD) information, a health information, and a fault information of each of the NVMe SSDs 160_1 to 160_N through the SMBus SB12, the I2C switch 150, and the SMBus SB13. Similarly, the BMC 120 may transmit the status information of each of the NVMe SSDs 160_1 to 160_N to the micro-controller 140 through the SMBus SB12, so that the micro-controller 140 may generate a drive signal to drive the corresponding light emitting diode in the light emitting diode module LEDM according to the status information of each NVMe SSD (for example, the NVMe SSD 160_1).

Since the number of input and output (IO) pins of the micro-controller 140 and the number of IO pins of the CPLD 130 are fixed, if the number of the NVMe SSDs of the electronic apparatus 100 is to be expanded, the number of the micro-controller 140 and the number of the CPLD 130 also have to be increased, and the firmware of all the micro-controller 140 and the firmware of all the CPLD 130 have to be updated. This not only significantly increases the hardware cost of the board of the electronic apparatus 100, but is also complex in terms of changing the hardware circuit design and the firmware design.

Referring to FIG. 2 hereinafter, FIG. 2 is another conventional electronic apparatus installed with NVMe SSDs. An electronic apparatus 200 includes a CPU 210, a BMC 220, a micro-controller 240, an I2C switch 250, a light emitting module LEDM, and a plurality of NVMe SSDs 260_1 to 260_N, wherein the micro-controller 240 may be, for example, a micro-controller “PSOC5” available from Cypress Semiconductor Corporation.

The CPU 210 may be coupled to the NVMe SSDs 260_1 to 260_N through the PCIe bus PB to read an information of each of the NVMe SSDs 260_1 to 260_N. In addition, the CPU 210 may also be coupled to the micro-controller 240 through a SMBus SB21, and the micro-controller 240 is coupled to the NVMe SSDs 260_1 to 260_N and the light emitting diode module LEDM, wherein the light emitting diode module LEDM has a plurality of light emitting diodes. The CPU 210 may obtain a PRSNT # information and an IFDET # information of each of the NVMe SSDs 260_1 to 260_N through the SMBus SB21 and the micro-controller controller 240. The CPU 210 may determine the hard disk type and the drive type of the NVMe SSD (for example, the NVMe SSD 260_1) according to the PRSNT # information and the IFDET # information of the NVMe SSD (for example, the NVMe SSD 260_1). In addition, the CPU 210 may transmit a status information of each of the NVMe SSDs 260_1 to 260_N to the micro-controller 240 through the SMBus SB21. The micro-controller 240 may generate a drive signal to drive the corresponding light emitting diode in the light emitting diode module LEDM according to the status information of each NVMe SSD (for example, the NVMe SSD 260_1), so that the user may determine the status of the NVMe SSD (for example, the NVMe SSD 260_1) by checking the light-on/light-off or color of the corresponding light emitting diode.

On the other hand, the BMC 220 is coupled to the micro-controller 240 and the I2C switch 250 through a SMBus SB22, wherein the I2C switch 250 is coupled to the NVMe SSDs 260_1 to 260_N through a SMBus SB23. Similarly, the BMC 220 may obtain the PRSNT # information and the IFDET # information of each of the NVMe SSDs 260_1 to 260_N through the SMBus SB22 and the micro-controller 240. Also, the BMC 220 may read a temperature value, a VPD information, a health information, and a fault information of each of the NVMe SSDs 260_1 to 260_N through the SMBus SB22 and the I2C switch 250. In addition, the BMC 220 may transmit the status information of each of the NVMe SSDs 260_1 to 260_N to the micro-controller 240 through the SMBus SB22. The micro-controller 240 may generate a drive signal to drive the corresponding light emitting diode in the light emitting diode module LEDM according to the status information of each NVMe SSD (for example, the NVMe SSD 260_1).

When the designer intends to expand the number of the NVMe SSDs of the electronic apparatus 200, it is only necessary to increase the number of the micro-controllers 240 and update the firmware of all the micro-controllers 240. Therefore, as compared to the circuit design of the electronic apparatus 100 of FIG. 1, the circuit design of the electronic apparatus 200 of FIG. 2 has a lower hardware cost and a lower complexity in terms of the hardware circuit design and the firmware design for expansion. However, increasing the number of the micro-controllers 240 will also result in a significant increase in power consumption of the electronic apparatus 200. Therefore, how to design the circuit of an electronic apparatus installed with NVMe SSDs so as to have a lower hardware cost, a lower complexity in terms of the hardware circuit design and the firmware design, and a lower power consumption is one of the major topics faced by persons skilled in the art.

### SUMMARY

In view of the above, the disclosure provides an electronic apparatus installed with non-volatile memory express solid state disks (NVMe SSDs), which has a lower hardware cost, a lower complexity in terms of the hardware circuit design and the firmware design, and a lower power consumption.

The electronic apparatus of the disclosure includes a processor, a board management controller (BMC), a micro-controller, at least one first input and output (TO) expander, and a plurality of NVMe SSDs. The micro-controller is coupled to the processor and the BMC. The at least one first IO expander is coupled to the micro-controller. The NVMe SSDs are coupled to the at least one first IO expander. The micro-controller reads a PRSNT # information and an IFDET # information of each of the NVMe SSDs through the at least one first IO expander, and transits the PRSNT # information and the IFDET # information of each of the NVMe SSDs to the processor and the BMC.

In an embodiment of the disclosure, the electronic apparatus further includes a light emitting diode module and at least one second IO expander. The at least one second IO expander is coupled between the micro-controller and the light emitting diode module. The processor or the BMC transmits a status information of each of the NVMe SSDs to the micro-controller, and the micro-controller generates a drive signal corresponding to the status information through the at least one second IO expander to drive at least one corresponding light emitting diode in the light emitting diode module.

In an embodiment of the disclosure, the electronic apparatus further includes an inter integrated circuit (I2C) switch. The I2C switch is coupled between the micro-controller and the NVMe SSDs. The micro-controller reads a vital product data (VPD) information of each of the NVMe SSDs through the I2C switch, and transmits the VPD information of each of the NVMe SSDs to the BMC.

Based on the above, the electronic apparatus installed with the NVMe SSDs according to the embodiment of the disclosure has a lower hardware cost, a lower complexity in terms of the hardware circuit design and the firmware design, and a lower power consumption. Also, it is easier to modify the hardware circuit and update the firmware when changing the number of the NVMe SSDs of the electronic apparatus.

To make the aforementioned and other features of the disclosure more comprehensible, several embodiments accompanied with drawings are described in detail as follows.

### BRIEF DESCRIPTION OF THE DRAWINGS

FIG. 1 is a conventional electronic apparatus installed with non-volatile memory express solid state disks (NVMe SSDs).

FIG. 2 is another conventional electronic apparatus installed with NVMe SSDs.

FIG. 3 is a circuit block diagram of an electronic apparatus installed with NVMe SSDs according to an embodiment of the disclosure.

### DETAILED DESCRIPTION OF DISCLOSED EMBODIMENTS

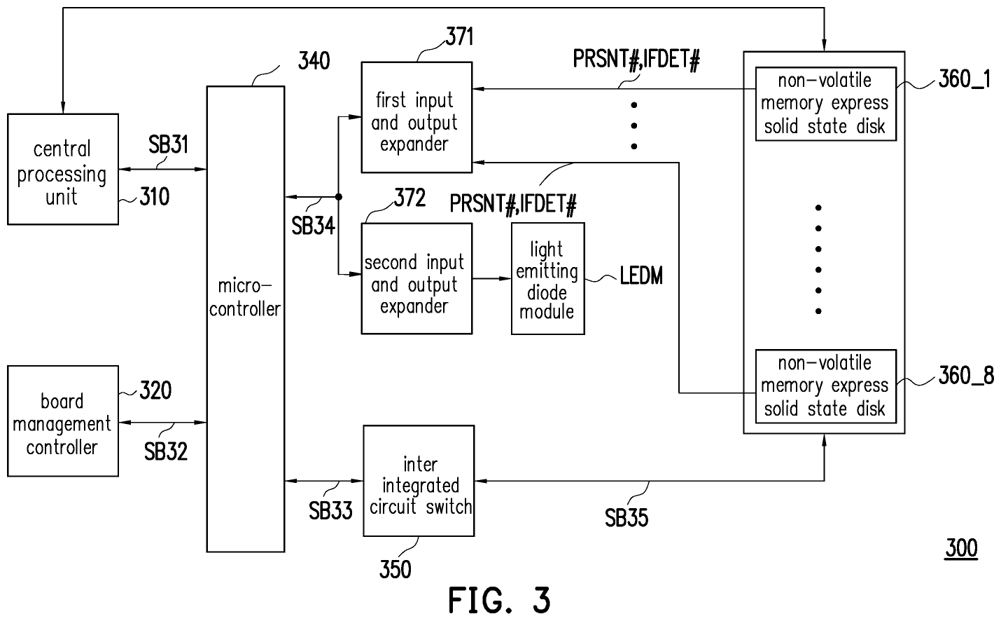

Referring to FIG. 3 hereinafter, FIG. 3 is a circuit block diagram of an electronic apparatus installed with non-volatile memory express solid state disks (NVMe SSDs) according to an embodiment of the disclosure. In an embodiment of the disclosure, an electronic apparatus 300 may be, for example, a server, a redundant array of independent disks (RAID) apparatus, or various data storage apparatus, etc., but the disclosure is not limited herein. The electronic apparatus 300 may include a processor 310, a board management controller (BMC) 320, a micro-controller 340 (single micro-controller), an inter integrated circuit (I2C) switch 350, at least one first input and output (IO) expander, at least one second IO expander, a light emitting diode module LEDM, and a plurality of NVMe SSDs. However, for ease of illustration and simplicity of drawing, the following embodiment will be exemplified with eight NVMe SSDs together with one first IO expander and one second IO expander, shown as a first IO expander 371, a second IO expander 372, and NVMe SSDs 360_1 to 360_8 in FIG. 3, wherein each of the first IO expander 371 and the second IO expander 372 may be, for example, an IO expander having one set of I2C pins and 16 general-purpose input and output (GPIO) pins, but the disclosure is not limited thereto. The following illustration may be used to analogize the implementation of an electronic apparatus installed with a different number of NVMe SSDs.

The micro-controller 340 is coupled to the processor 310, the BMC 320, the first IO expander 371, the second IO expander 372, and the I2C switch 350. The first IO expander 371 is coupled between the micro-controller 340 and the NVMe SSDs 360_1 to 360_8. The second IO expander 372 is coupled between the micro-controller 340 and the light emitting diode module LEDM, wherein the light emitting diode module LEDM has a plurality of light emitting diodes. The I2C switch 350 is coupled between the micro-controller 340 and the NVMe SSDs 360_1 to 360_8.

Further, the micro-controller 340 is coupled to the processor 310, the BMC 320, the I2C switch 350, and the I2C pins of the first IO expander 371 and the I2C pins of the second IO expander 372 respectively through a first bus SB31, a second bus SB32, a third bus SB33, and a fourth bus SB34. The I2C switch 350 is coupled to the NVMe SSDs 360_1 to 360_8 through a fifth bus SB35. Each of the first bus SB31, the second bus SB32, the third bus SB33, the fourth bus SB34, and the fifth bus SB35 may be, for example, a system management bus (SMBus), but the disclosure is not limited thereto. In addition, the GPIO pins of the first IO expander 371 are coupled to the NVMe SSDs 360_1 to 360_8 for receiving a PRSNT # information and an IFDET # information of each of the NVMe SSDs 360_1 to 360_8. The GPIO pins of the second IO expander 372 are coupled to the light emitting diode module LEDM for outputting drive signals to drive the light emitting diodes of the light emitting diode module LEDM.

In terms of operation, the micro-controller 340 may read the PRSNT # information and the IFDET # information of each of the NVMe SSDs 360_1 to 360_8 through the first IO expander 371, and the micro-controller 340 may read a vital product data (VPD) information, a temperature value, a health information, or a fault information, etc. of each of the NVMe SSDs 360_1 to 360_8 through the I2C switch 350. The micro-controller 340 may consolidate data such as the PRSNT # information, the IFDET # information, the VPD information, the temperature value, the health information, or the fault information of each of the NVMe SSDs 360_1 to 360_8, so that when the processor 310 or the BMC 320 requires such data, the micro-controller 340 may provide the data to the processor 310 or the BMC 320 immediately. As a result, the micro-controller 340 may reduce the time delay for the processor 310 and the BMC 320 to read the data, thereby effectively improving the overall performance of the processor 310 and the BMC 320.

The processor 310 or the BMC 320 may determine the hard disk type and the drive type of the NVMe SSD (for example, the NVMe SSD 360_1) according to the obtained PRSNT # information and the obtained IFDET # information of the NVMe SSD (for example, the NVMe SSD 360_1). In addition, the processor 310 or the BMC 320 may analyze and process the data such as the VPD information, the temperature value, the health information, or the fault information of each of the NVMe SSDs 360_1 to 360_8, and generate and provide a status information corresponding to each of the NVMe SSDs 360_1 to 360_8 to the micro-controller 340. Then, the micro-controller 340 may generate a drive signal according to the status information of each of the NVMe SSDs 360_1 to 360_8 to drive the corresponding light emitting diode in the light emitting diode module LEDM. In this way, the user may determine the status of the corresponding NVMe SSD by checking the light-on/light-off or color of the corresponding light emitting diode.

In an embodiment of the disclosure, the processor 310, the BMC 320, and the I2C switch 350 may be implemented by respectively adopting an existing central processor unit, an existing board management controller, and an existing I2C switch integrated circuit.

In an embodiment of the disclosure, the micro-controller 340 may be implemented by adopting a LPC824 micro-controller or other micro-controller having the same performance, but is not limited herein, and the disclosure does not limit the implementation of the micro-controller 340.

In an embodiment of the disclosure, each of the first IO expander 371 and the second TO expander 372 may be implemented by adopting a PCA9555 IO expander integrated circuit or other IO expander integrated circuit with the same performance, but is not limited herein, and the disclosure does not limit the implementation of the first IO expander 371 and the second IO expander 372.

It is worth mentioning that the number of first IO expander and second IO expander of the disclosure may be determined according to the number of the NVMe SSDs installed on the electronic apparatus and managed by the electronic apparatus. For example, it is assumed here that the status of each NVMe SSD is indicated by two light emitting diodes. Therefore, in the embodiment shown in FIG. 3, the eight NVMe SSDs 360_1 to 360_8 will provide a total of eight PRSNT # information and eight IFDET # information, and sixteen light emitting diodes are required to indicate the statuses of the eight NVMe SSDs 360_1 to 360_8, such that one first IO expander (having 16 GPIO pins) is required to receive the eight PRSNT # information and the eight IFDET # information, and one second IO expander (having 16 GPIO pins) is required to output sixteen drive signals to respectively drive the sixteen light emitting diodes.

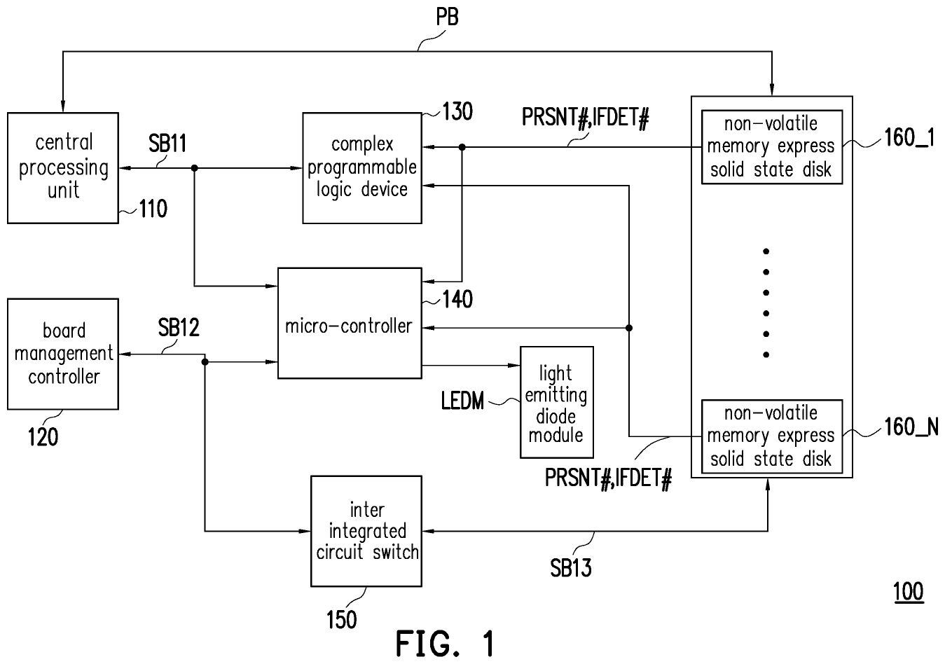

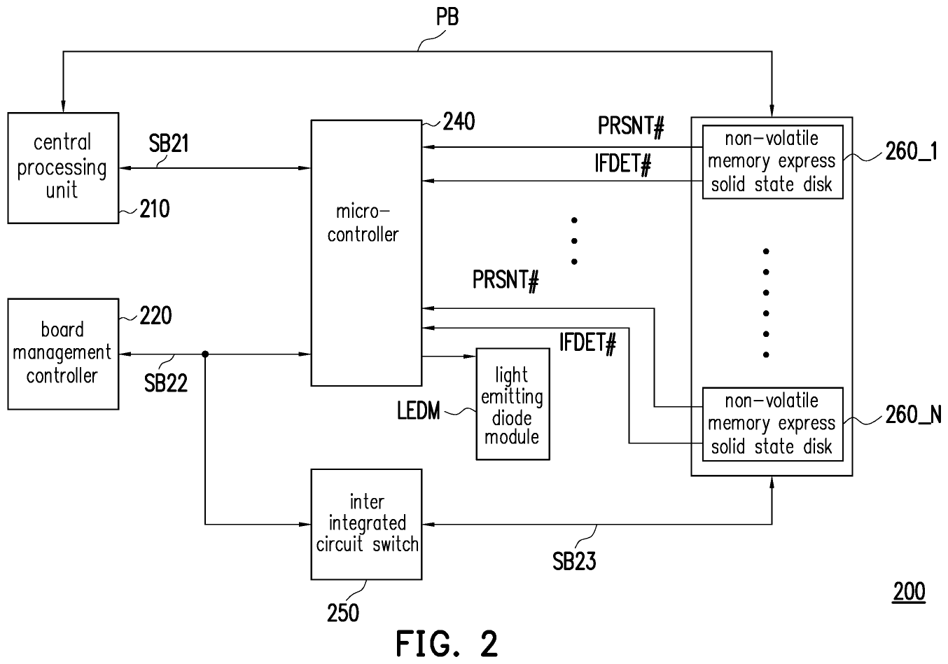

In addition, if the electronic apparatus 300 of FIG. 3 has to be installed with and manage thirty-two NVMe SSDs, it is only required to expand the number of the first IO expanders 371 from one to four and expand the number of the second IO expanders 372 from one to four. The number of the micro-controller 340 does not have to be increased. Therefore, as compared to when the circuit design of the electronic apparatus 100 of FIG. 1 is required to expand the number of NVMe SSDs, in which the number of the micro-controllers 140 and the CPLDs 130 has to be increased, and the firmware of all the micro-controllers 140 and all the CPLDs 130 has to be updated; and as compared to when the circuit design of the electronic apparatus 200 of FIG. 2 is required to expand the number of NVMe SSDs, in which the number of the micro-controllers 240 has to be increased and the firmware of all the micro-controllers 240 has to be updated, when the circuit design of the electronic apparatus 300 of FIG. 3 according to the disclosure is required to expand the number of NVMe SSDs, it is only required to increase the number of the first IO expanders 371 and the second IO expanders 372 and update the firmware of the micro-controller 340 (single micro-controller). Therefore, the circuit design of the electronic apparatus 300 of FIG. 3 has a lower hardware cost (since the price of IO expander is lower than the price of micro-controller and the price of CPLD) and a lower complexity in terms of the hardware circuit design and the firmware design. In addition, since the power consumption of IO expander is lower than the power consumption of micro-controller and the power consumption of CPLD, the circuit design of the electronic apparatus 300 of FIG. 3 has a relatively lower power consumption.

In summary, the electronic apparatus installed with the NVMe SSDs according to the embodiment of the disclosure has a lower hardware cost, a lower complexity in terms of the hardware circuit design and the firmware design, and a lower power consumption. Also, it is easier to modify the hardware circuit and update the firmware when changing the number of NVMe SSDs of the electronic apparatus.

Although the disclosure has been disclosed in the above embodiments, the embodiments are not intended to limit the disclosure. It will be apparent to persons skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic apparatus installed with a non-volatile memory express solid state disk (NVMe SSD), comprising:
a processor;
a board management controller (BMC);
a micro-controller coupled to the processor and the BMC;
at least one first input and output (IO) expander coupled to the micro-controller; and
a plurality of NVMe SSDs coupled to the at least one first IO expander,
wherein the micro-controller reads a PRSNT # information and an IFDET # information of each of the plurality of NVMe SSDs through the at least one first IO expander, and the micro-controller transmits the PRSNT # information and the IFDET # information of each of the plurality of NVMe SSDs to the processor and the BMC.

2. The electronic apparatus installed with the NVMe SSD according to claim 1, further comprising:
a light emitting diode module; and
at least one second IO expander coupled between the micro-controller and the light emitting diode module,
wherein the processor or the BMC transmits a status information of each of the plurality of NVMe SSDs to the micro-controller, and the micro-controller generates a drive signal corresponding to the status information through the at least one second IO expander to drive at least one corresponding light emitting diode in the light emitting diode module.

3. The electronic apparatus installed with the NVMe SSD according to claim 2, further comprising:
an internal integrated circuit (I2C) switch coupled between the micro-controller and the plurality of NVMe SSDs,
wherein the micro-controller reads a vital product data (VPD) information of each of the plurality of NVMe SSDs through the I2C switch and transmits the VPD information of each of the plurality of NVMe SSDs to the BMC.

4. The electronic apparatus installed with the NVMe SSD according to claim 3, wherein the micro-controller is coupled to the processor through a first bus, the micro-controller is coupled to the BMC through a second bus, the micro-controller is coupled to the I2C switch through a third bus, and the micro-controller is coupled to the at least one first IO expander and the at least one second IO expander through a fourth bus, wherein each of the first bus, the second bus, the third bus, and the fourth bus is a system management bus.

5. The electronic apparatus installed with the NVMe SSD according to claim 2, wherein each of the at least one first IO expander and the at least one second IO expander is a PCA9555 IO expander integrated circuit.

6. The electronic apparatus installed with the NVMe SSD according to claim 1, wherein the micro-controller is an LPC824 micro-controller.
